(19) United States
(12) Patent Application Publication
(10) Pub. No.: US 2006/0125893 A1
(43) Pub. Date: Jun. 15, 2006

(54) Inkjet cartridge and method of fabricating the same

(76) Inventors: Jae-Cheol Lee, Hwaseong-gun (KR); Sik-Sun Choi, Osan-si (KR)

Correspondence Address: STANZIONE & KIM, LLP, 919 18TH STREET, N.W., SUITE 440, WASHINGTON, DC, 20006, US

(21) Appl. No.: 11/259,116

(22) Filed: Oct. 27, 2005

(30) Foreign Application Priority Data
Dec. 10, 2004 (KR) 2004-104483

(51) Int. Cl. B41J 2/175

(52) U.S. Cl. 347/87

(57) ABSTRACT

An inkjet cartridge and a method of fabricating the same. The inkjet cartridge includes a cartridge body to store ink therein, a head attached to the cartridge body to eject the ink stored in the cartridge body externally, a flexible printed circuit board attached to the cartridge body to be electrically connected to the head, a sealant to seal a electrical connection portion of the head and the flexible printed circuit board, and a surface treatment portion which is locally surface-treated on the flexible printed circuit board. Since the flexible printed circuit board, at which the sealant is applied, is locally surface-treated, an area and a height of a profile of the sealant applied formed on the flexible printed circuit board are controlled to have a small size.

### CROSS-REFERENCE TO RELATED APPLICATIONS

This application claims the benefit under 35 U.S.C § 119 of Korean Patent Application No. 2004-104483, filed Dec. 10, 2004, in the Korean Intellectual Property Office, the disclosure of which is incorporated herein by reference in its entirety.

### BACKGROUND OF THE INVENTION

1. Field of the Invention

The present general inventive concept relates to an inkjet cartridge and a method of fabricating the same, and more particularly, to an inkjet cartridge having an improved sealing portion and a method of fabricating the same.

2. Description of the Related Art

An inkjet cartridge is a device for ejecting ink stored therein in an ink droplet shape depending on electric signals when the electrical signals are input from an external device to print a predetermined image on a recording medium. The inkjet cartridge typically includes a head having ink ejecting means, a cartridge body having the head attached thereto, and a flexible printed circuit board (FPC) attached to the cartridge body.

The FPC is electrically connected to the head to transmit the electric signals input from the external device to the head. Therefore, when the electric signals output from the external device, such as a computer and so on, are input into the FPC, the electrical signals are transmitted to the head through the FPC. As a result, the ink ejecting means ejects the ink stored therein to an exterior based on the electric signals.

In this process, since an electrical connection part of the FPC and the head is exposed to the exterior, it may be electrically shorted due to the ink or be subjected to physical attack from the exterior. Therefore, a predetermined sealant has been applied on the electrical connection part connected as described above.

In addition, after the sealant is applied, the cartridge is filled with the ink. However, when the inkjet cartridge is filled with the ink without sealing a nozzle of the cartridge, the ink filled in the cartridge may be undesirably leaked through the nozzle during distribution of the cartridge. Therefore, an operator seals the nozzle of the inkjet cartridge, in which the ink was filled, with a nozzle tape and so on, and then the cartridge is distributed. As a result, a user uses the inkjet cartridge after removing the nozzle tape.

Meanwhile, in order to protect the electrical connection part of the head and the FPC, the applied sealant should maintain its performance during a storage period of the cartridge. In general, the recommended storage period of the cartridge is more than two years. Therefore, the sealant also should maintain the sealing performance with attached to the FPC for more than two years. For this reason, recently, various methods for improving adhesion of the sealant have been proposed and performed.

The methods for improving adhesion of the sealant include surface treatment methods of the FPC, such as a plasma surface treatment method, a chemical surface treatment method, a corona surface treatment method, an ion beam surface treatment method, and so on. Therefore, the FPC of the inkjet cartridge is surface-treated on the entire surface thereof using the surface treatment methods as described above before the FPC is attached to the cartridge body. As a result, the sealant applied to the inkjet cartridge may maintain the sealing performance for a long time more than two years through the surface treatment of the FPC as described above.

However, while the inkjet cartridge manufactured as described above has an advantage that the adhesion of the sealant may be maintained in spite of long-term use, new problems also have been found.

That is, when the entire surface of the FPC included in the conventional inkjet cartridge is surface-treated, since the adhesion of the sealant attached to the FPC as well as spread-out properties (hydrophilicity) of the sealant applied to the FPC are remarkably improved, a profile of the sealant formed by the application as described above has a large area and a large height. Therefore, after the cartridge is manufactured using the FPC, when the nozzle tape is attached to a bottom surface of the cartridge to seal the nozzle, a lifted-off portion, at which the nozzle tape is lifted off at the bottom surface of the cartridge, is formed by tension of the nozzle tape and a pair of the sealants formed at both sides of the bottom surface. As a result, a portion of the nozzle, which is to be sealed by the nozzle tape, is exposed to the exterior through the lifted-off portion. Therefore, the ink stored in the cartridge leaks through the exposed portion of the nozzle causing a nozzle-clogging phenomenon.

In addition, when the profile of the sealant formed by the application as described above has a large area and a large height, while wiping the bottom surface of the cartridge to prevent the nozzle-clogging phenomenon of the inkjet cartridge, it is impossible that a wiper fully wipes the entire nozzle, due to the profile of the sealant having a very large area and a very large height. Especially, in a case of the nozzle formed adjacent to the sealant, since the wiper skips over the nozzle due to the high profile of the sealant, the nozzle formed at the skipped part is not continuously wiped. Therefore, the nozzle formed at the skipped part is often clogged.

### SUMMARY OF THE INVENTION

The present general inventive concept provides an inkjet cartridge and a method of fabricating the same, capable of minimizing a lift-off phenomenon of a nozzle tape.

The present general inventive concept also provides an inkjet cartridge and a method of fabricating the same, capable of reducing an area and a height of a sealant profile such that all nozzles may be wiped.

The present general inventive concept also provides an inkjet cartridge and a method of fabricating the same, capable of forming a sealant profile to a desired area and a desired height.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an inkjet cartridge including a cartridge body to store ink therein, a head attached to the cartridge body to eject the ink stored in the cartridge body externally, a flexible printed circuit board (FPC) attached to the cartridge body to be electrically connected to the head, a sealant to seal an electrical connection portion of the head and the flexible printed circuit board, and a surface treatment portion which is locally surface-treated in a region in which the sealant is formed in the flexible printed circuit board.

The surface treatment portion may be ion beam-treated.

The surface treatment portion may have a contact angle of substantially 1˜30°.

The surface treatment portion may be disposed around the electrical connection portion.

The head may include pads as electrical input and output terminals, and the FPC may include leads exposed externally to be electrically connected to the pads. In this case, the surface treatment portion may be disposed around the lead.

The head may further include a nozzle to eject the ink, and the FPC may include a nozzle exposing part to expose the nozzle externally. In this case, the surface treatment portion may be disposed around the nozzle exposing part.

The foregoing and/or other aspects and advantages of the present general inventive concept may also be achieved by providing a method of fabricating an inkjet cartridge, the method including preparing a cartridge body having a head attached thereto, and a flexible printed circuit board (FPC) having a conductive trace, locally surface-treating the FPC, electrically connecting leads of the conductive trace to pads of the head, and applying a sealant to the surface treatment portion and the electrical connection portion.

The method may further include attaching the surface-treated FPC to the cartridge body between the electrically connecting operation and the sealant applying operation.

The method may further include attaching a nozzle tape to the cartridge body to seal the nozzle of the head, after the sealant applying operation.

The foregoing and/or other aspects and advantages of the present general inventive concept may be achieved by providing a method of surface-treating a flexible printed circuit board (FPC) of an inkjet cartridge, the method including preparing a mask having a predetermined sized opening and an FPC having a conductive trace disposed therein, disposing the mask above the FPC, and irradiating an ion beam toward the FPC from an upper side of the mask to locally surface treat the FPC.

The method may further include injecting a reaction gas to the FPC. In this case, the reaction gas may be one of an oxygen gas and a nitrogen gas.

The FPC may include a lead having one end connected to the conductive trace and the other end exposed externally. In this case, the mask may be disposed to allow an opening to be aligned with the lead.

The FPC may further include an opened nozzle exposing part, and the lead may be exposed in the nozzle exposing part. In this case, the opening may have a size larger than that of the nozzle exposing part.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an inkjet cartridge according to an embodiment of the present general inventive concept;

FIG. 2 is a cross-sectional view illustrating the inkjet cartridge of FIG. 1 taken along a line l-l;

FIG. 3 is a conceptual view illustrating a state in which a wiper is wiping a head of the inkjet cartridge of FIG. 2;

FIG. 4 is a conceptual view illustrating a state in which a contact angle of a surface treatment portion included in an FPC of the inkjet cartridge of FIG. 1 is measured;

FIGS. 5A to 5F are views illustrating a method of fabricating the inkjet cartridge of FIG. 1;

FIG. 6 is a flow chart illustrating a method of fabricating an inkjet cartridge according to an embodiment of the present general inventive concept; and

FIG. 7 is a flow chart illustrating a method of surface-treating an FPC of an inkjet cartridge according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. At this time, in the drawings, the sizes and shapes are exaggerated for clarity.

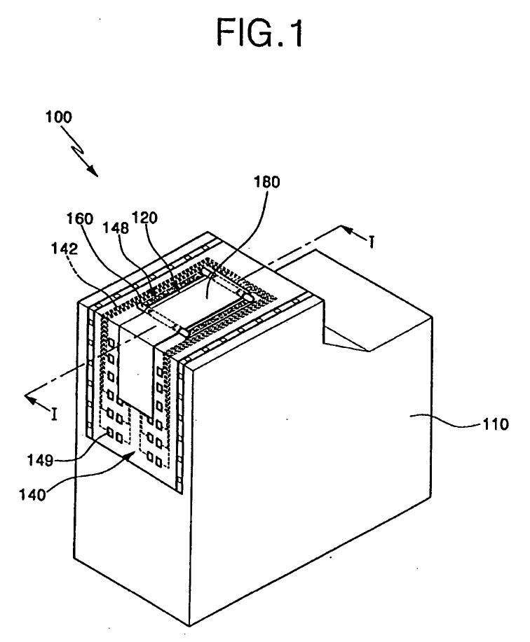

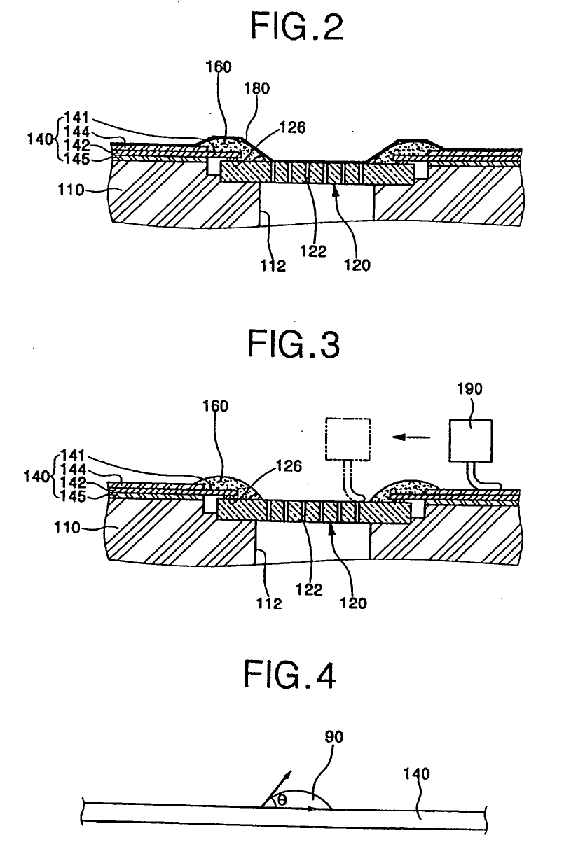

FIG. 1 is a perspective view illustrating an inkjet cartridge 100 according to an embodiment of the present general inventive concept, FIG. 2 is a cross-sectional view illustrating the inkjet cartridge 100 of FIG. 1 taken along a line l-l, and FIG. 3 is a conceptual view illustrating a state in which a wiper is wiping a head of the inkjet cartridge 100 of FIG. 2.

Referring to FIGS. 1 to 3, the inkjet cartridge 100 includes a cartridge body 110 to store ink therein, a head 120 attached to a top surface of the cartridge body 110 to eject the ink stored in the cartridge body 110 externally, a flexible printed circuit board (FPC) 140 electrically connected to the head 120, and a sealant 160 to seal an electrical connection portion of the head 120 and the FPC 140. The cartridge body 110 may be a conventional cartridge body.

The cartridge body 110 is formed to have a container shape, and includes an ink storage space (not shown) to store the ink therein. An ink-supply passage 112 is disposed in the cartridge body 110, and a head mounting part (not shown) to mount the head 120 is disposed at a top end of the ink-supply passage 112. Therefore, the head 120 is mounted on the head mounting part, and the ink stored in the cartridge body 110 is supplied to the head 120 attached to the top surface of the cartridge body 110 through the ink-supply passage 112.

The head 120 includes a substrate (not shown) attached to the head mounting part, an ink ejecting unit (not shown) disposed on the substrate, a chamber layer (not shown) disposed on the substrate to surround the ink ejecting unit, a nozzle layer disposed on the chamber layer, and pads 126 electrically connected to the ink ejecting unit and disposed on the substrate.

The substrate can be formed of silicon and the like, and adheres to a top surface of the head mounting part by an adhesive agent, such as a sealant. An ink-feed hole (not shown) is formed through the substrate to communicate with the ink-supply passage 112. Therefore, the ink stored in the cartridge body 110 is supplied into the ink-feed hole along the ink-supply passage 112.

The ink ejecting unit causes the ink supplied via the ink-feed hole to eject externally through a nozzle 122, and the ink ejecting unit is disposed at one side or both sides of the ink-feed hole. The ink ejecting unit may be a thermal resistor or a piezoelectric material.

The chamber layer surrounds the ink ejecting unit to provide a predetermined space (hereinafter, referred to as a “chamber”) to receive the ink supplied through the ink-feed hole by a predetermined amount. The ink ejecting unit may be disposed at a center portion of the chamber.

The nozzle layer is disposed on the chamber layer to seal the chamber layer, and includes the nozzle 122 to eject the ink. The nozzle 122 may be disposed above the ink ejecting unit, i.e., at a position corresponding to the ink ejection unit. Therefore, when the ink ejecting operates, the ink stored in the chamber is ejected externally through the nozzle 122 of the nozzle layer. In this process, the chamber layer and the nozzle layer may be made of one of imides-based, epoxy-based, and acrylate-based polymer layers. A nozzle tape 180 can be provided at the nozzle 122 to prevent ink from leaking through the nozzle 122.

The pads 126, are disposed at outer sides of the chamber to be exposed externally, and receive electrical signals externally and transmit the received electrical signals to the ink ejecting unit. The pads 126 may be conductive metal, such as aluminum, or a metal alloy. In addition, the pads 126 are electrically connected to a plurality of conductive traces 142 of the FPC 140. Specifically, the pads 126 adhere to a projection of each conductive trace 142 projecting externally from the FPC 140 by a TAB bonder (not shown) or the like. Therefore, the pads 126 receive the electrical signals through the plurality of conductive traces 142 of the FPC 140 and transmit the received electrical signals to the ink ejecting unit.

The FPC 140 has a first end attached to the top surface of the cartridge body 110 to cover the head 120, and a second end extending by a predetermined length to be attached to a side surface of the cartridge body 110. An opening is disposed at the first end of the FPC 140 attached to the top surface of the cartridge body 110 to expose the nozzle 122 of the head 120 externally, connection terminals 149 to electrically connect to a printer main body (not shown) are disposed at the second end of the FPC 140 attached to the side surface of the cartridge body 110, and the plurality of conductive traces 142 are connected to the connection terminals 149 and disposed on the FPC 140 in a predetermined manner.

Specifically, a first end of each conductive trace 142 is connected to the connection terminal 149, and a second end (hereinafter referred to as a “lead”) 141 of the conductive trace 142 projects from the FPC 140 to adhere to the pad 126. Therefore, the electrical signals applied from the printer main body through each connection terminal 149 are transmitted to the ink ejecting unit through the conductive trace 142, the lead 141 of the conductive trace 142, and the pad 126 connected to the lead 141, and the ink ejecting unit causes the ink to eject through the nozzle 122 according to the electrical signals. The FPC 140 can also include upper and lower insulating layers 144 and 145 to insulate the conductive traces 142.

Meanwhile, in order to increase adhesion of the sealant 160 and to form a profile of the sealant 160 to a desired area and height, a surface treatment portion 148 to define a region of the FPC 140 at which the sealant 160 is to be applied and formed, such that the defined region is locally surface-treated in advance of the application of the sealant 160 is formed on the FPC 140. The surface treatment portion 148 may be formed on the upper insulating layer 144 and the lead 141 of the FPC 140. The surface treatment portion 148 may be surface-treated by various methods.

Therefore, tested ink-resistance of various materials surface-treated by the various methods are illustrated Table 1, in order to confirm an increase effect of the adhesion of the sealant depending on a type of the surface treatment.

TABLE 1
Treatment

| | Non- | Plasma | Chemical | | | Ion beam | | |
|---|---|---|---|---|---|---|---|---|
| | treatment | 540 W/Ar | Silane | Silane | Corona | #A | #B | #C |
| Material | (C.A:60°) | 5 sccm/11 min | 403 | 603 | — | (C.A:7°) | (C.A:20°) | (C.A:31°) |
| a Material | 5 weeks | 5 weeks | 3 weeks | 7 weeks | 1 week | 9 weeks | 9 weeks | 7 weeks |
| b material | 2 weeks | 8 weeks | 2 weeks | 8 weeks | 2 weeks | Not less | 6 weeks | 7 weeks |
| | | | | | | than 11 | | |
| | | | | | | weeks | | |
| c material | 5 weeks | 9 weeks | 4 weeks | 8 weeks | 1 week | Not less | Not less | 10 weeks |
| | | | | | | than 11 | than 11 | |
| | | | | | | weeks | weeks | |

Table 1 was generated by treating each material (a, b, and c) on a Upilex material surface with each type of treatment, curing the treated material, dipping the cured material in 60° ink, and then observing periodically to judge whether the material and the ink are separated.

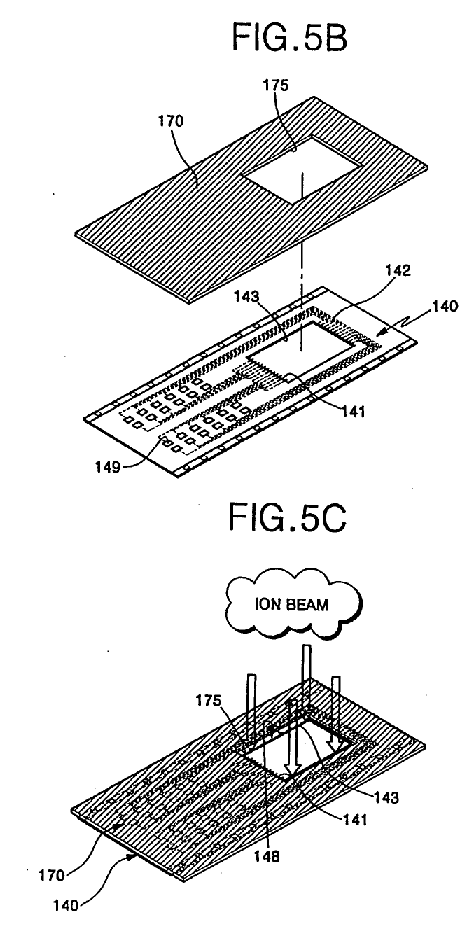

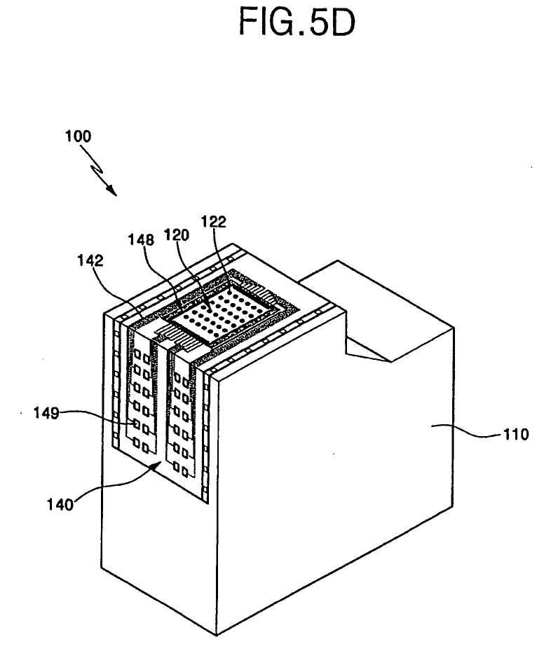

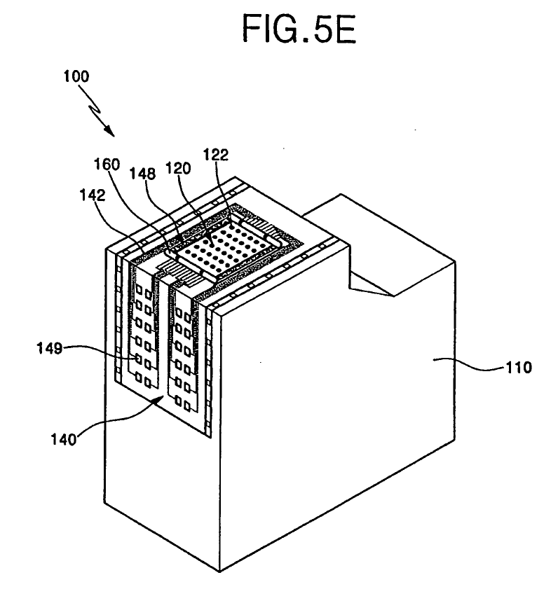

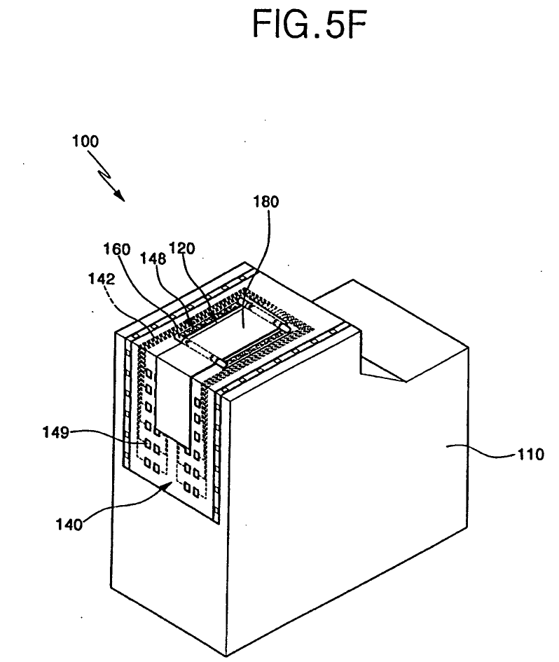

As illustrated in Table 1, the surfaces of the materials treated by the ion beam have excellent ink-resistant properties. That is, referring to Table 1, the adhesion of the sealant 160 is remarkably increased when the FPC 140 is ion beam-treated. Therefore, the surface treatment portion 148 of the FPC 140 can be surface-treated by the ion beam treatment method, as well as the various other surface treatment methods. The surface treatment portion 148 may be disposed around the electrical connection portion, at which the head 120 and the FPC 140 are connected to each other, around the lead 141 of the FPC 140, or around a nozzle exposure portion 143 (see FIGS. 5A-5F). Therefore, the sealant 160 applied at the surface treatment portion 148 has an increased adhesion due to the surface treatment, and the profile of the sealant 160 has a uniform area and height due to the local surface treatment.

The surface treatment portion 148 of the FPC 140 is surface-treated by disposing a metal mask 170 (see FIGS. 5B and 5C) having an opening 175 (see FIGS. 5B and 5C) of a predetermined sized above the FPC 140, and then irradiating an ion beam generated from a predetermined ion source toward a surface of the FPC 140 together with injecting reaction gases, such as oxygen gas, nitrogen gas or the like, to the surface. As a result, the surface treatment portion 148 of the FPC 140, is changed from a hydrophobic surface to a hydrophilic surface. Therefore, the sealant 160 applied on the hydrophilic surface has an increased adhesion.

The ion source used to irradiate the ion beam may employ a Kaufman type ion source, a cold hollow cathode ion source, a high frequency ion source, or the like. In addition, an amount of the ion beam irradiated on the surface treatment portion 148 can be in a range of about 10¹³ ˜10¹⁸ ions/cm², and an amount of the reaction gases injected to the surface treatment portion 148 can be in a range of about 0˜30 ml/min.

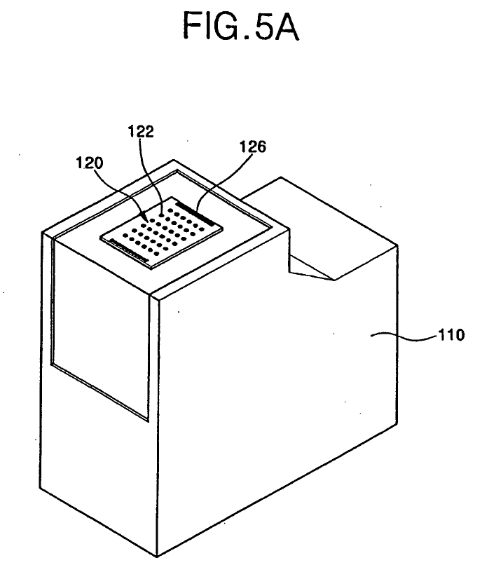

FIG. 4 is a conceptual view illustrating a state in which a contact angle θ of the surface treatment portion 148 of the FPC 140 of the inkjet cartridge 100 is measured. Referring to FIGS. 1-4, hydrophobicity or hydrophilicity of the surface treatment portion 148 is measured by measuring a contact angle of a drop of water 90 attached to the surface thereof.

In general, a low contact angle θ represents hydrophilicity (high wettability) and high surface energy, and a high contact angle θ represents hydrophobicity (low wettability) and low surface energy. Therefore, in order to increase the adhesion of the sealant 160, the surface of the FPC 140 should have a low contact angle θ, i.e., high hydrophilicity. While the non-treated FPC 140 can have a contact angle of about 60°, the ion beam-treated FPC 140 has a contact angle θ of not more than 35°. Referring to Table 1, the FPC 140 has excellent adhesion properties when it has a contact angle θ of 7°. Therefore, the surface treatment portion 148 can be ion beam-treated to have a low contact angle. For example, the contact angle θ of the surface treatment portion 148 can be in a range of about 1 ˜30°.

The sealant 160 seals the electrical connection portion of the FPC 140 and the head 120 to protect the electrical connection portion, and is formed by applying a material, such as a photosensitive polymer layer, a thermosetting polymer layer, or the like, on the top surface of the FPC, and then curing the applied portion using UV or heat. At this time, the thermosetting polymer layer may be an epoxy-based, acrylate-based, or imides-based polymer layer.

Specifically, the sealant 160 is formed by applying a material, such as a photosensitive polymer layer, a thermosetting polymer layer, or the like, on the top surface of the surface treatment portion 148 of the FPC 140 after the surface treatment portion 148 is surface treated locally. Therefore, while the adhesion of the sealant 160 is increased due to hydrophilicity of the surface treatment portion 148, the area and height of the profile of the sealant 160 is controlled to a desired size due to the hydrophilicity of the surface treatment portion 148, which is locally surface-treated. Since the area and height of the profile of the sealant 160 is controlled to the desired size, a wiper 190 can efficiently wipe the nozzle 122 of the head 120 without interference from the profile of the sealant 160, as illustrated in FIG. 3.

The nozzle exposure portion 143 is a portion of the FPC 140 which is opened by a predetermined size to expose the nozzle 122 of the head 120.

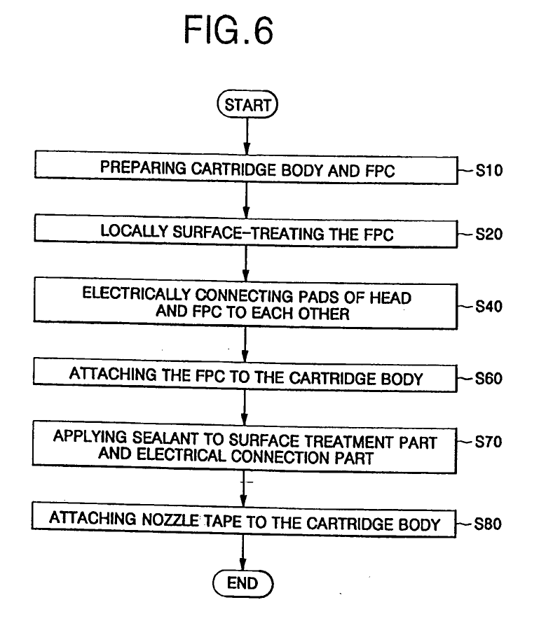

FIGS. 5A to 5F and FIG. 6 illustrate a method of fabricating the inkjet cartridge 100 according to an embodiment of the present general inventive concept.

Referring to FIGS. 5A-5F and FIG. 6, first, the cartridge body 110 having the head 120 attached thereto and the FPC 140 having the conductive trace 142 are prepared, as illustrated in FIG. 5A (S10). An operator locally surface treats the FPC 140 to form the surface treatment portion 148 in order to control the height and area of the profile of the sealant 160, which is to be applied and formed on the FPC 140, as illustrated in FIGS. 5B and 5C (S20).

Specifically, the operator positions the mask 170 having the opening 175 of a predetermined size above the FPC 140, and then an ion beam generated from a predetermined ion source is irradiated toward a surface of the FPC 140 together with injecting reaction gases such as oxygen gas or nitrogen gas to the surface. Therefore, a portion of the surface of the FPC 140 corresponding to the opening 175 of the mask 170 (i.e., the aforementioned surface treatment portion 148) is changed from a hydrophobic surface to a hydrophilic surface by the ion beam treatment process. Therefore, an adhesion of the sealant 160 applied and formed on the surface treatment portion 148 is remarkably increased.

Next, when the FPC 140 is locally surface-treated at the surface treatment portion 148, the operator electrically connects the lead 141 of the conductive trace 142 to the pads 126 of the head 120 using a method such as a TAB bonding method (S40).

When the pads 126 of the head 120 and the lead 141 of the conductive trace 142 are electrically connected to each other, the operator attaches the locally surface-treated FPC 140 to the cartridge body 110, as illustrated in FIG. 5D (S60). At this time, the operator attaches the FPC 140 to allow the nozzle exposure portion 143 of the FPC 140 to be located around the nozzle 122 of the head 120. Therefore, the ink in the cartridge body 110 is ejected externally through the nozzle 122 of the head 120 exposed by the nozzle exposure portion 143 of the FPC 140.

Next, as illustrated in FIG. 5E, when the FPC 140 is attached to the cartridge body 110, the operator applies the sealant 160 on an electrical connection portion using a needle dispenser (not shown) such that the electrical connection portion of the pads 126 of the head 120 and the lead 141 is sealed, and then the operator cures the sealant 160 by applying UV or heat (S70). Therefore, the electrical connection portion is protected by the sealant 160.

Specifically, the operator forms the sealant 160 by applying a material, such as a photosensitive polymer layer or a thermosetting polymer layer, on a top surface of the surface treatment portion 148 of the FPC 140. The sealant 160 has a profile of a small height and a small area, since the sealant 160 is formed on a region at which the adhesion is increased but locally limited, i.e., the surface treatment portion 148, by virtue of the hydrophilicity of the surface treatment portion 148, which can be ion beam-treated. Therefore, when a top surface of the head 120 is wiped in order to prevent the nozzle 122 of the inkjet cartridge 100 from clogging, since the wiper 190 (see FIG. 3) performs a wiping operation by riding over the sealant 160 formed to the small height, all the nozzles 122 formed at the head 120 may be wiped. As a result, it is possible to solve a clogging problem of the nozzle 122 generated due to imperfect wiping.

Next, as illustrated in FIG. 5F, when the electrical connection portion of the pads 126 of the head 120 and the lead 141 is sealed by the sealant 160, the operator fills the cartridge body 110 with the ink, and then seals the nozzle 122 exposed externally with the nozzle tape 180, or the like (S80), thereby completing the fabrication of the inkjet cartridge 100. Since the profile of the sealant 160 is formed to have a small height and a small area, a lift-off phenomenon of the nozzle tape 180 generated when the operator seals the nozzle 122 with the nozzle tape 180 is minimized. Therefore, since the nozzle 122 of the head 120 is sealed by the nozzle tape 180, it is possible to prevent leakage of the ink.

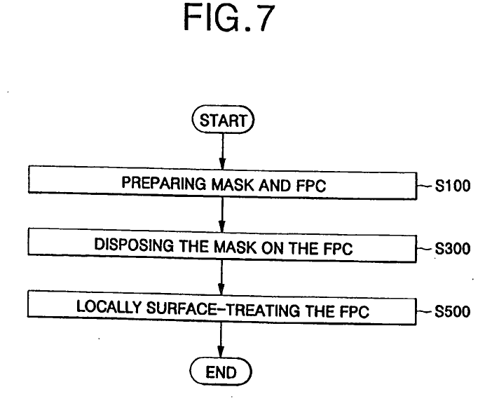

FIG. 7 illustrates a method of surface-treating an FPC 140 of an inkjet cartridge 100 according to an embodiment of the present general inventive concept.

Referring to FIGS. 5B-5C and 7, the mask 170 having the opening 175 of the predetermined size and the FPC 140 having the conductive trace 142 are provided, as illustrated in FIG. 5B (S100). An operator positions the mask 170 above the FPC 140 (S300). At this time, a nozzle exposure portion 143 which is opened to a predetermined size to expose a nozzle 122 of a head 120 is disposed at the FPC 140, a lead 141 connected to a conductive trace 142 is exposed at an inner side of the nozzle exposure portion 143, and the opening 175 of the mask 170 is disposed above the nozzle exposure portion 143. At this time, the opening 175 of the mask 170 is formed to have a size larger than that of the nozzle exposure portion 143. Therefore, the circumference of the nozzle exposure portion 143, i.e., the circumference of the lead 141, is exposed toward an upper side of the mask 170 through the opening 175 of the mask 170.

Then, when the mask 170 is positioned above the FPC 140, the operator irradiates an ion beam toward the FPC 140 from the upper side of the mask 170 using an ion beam treatment apparatus (not shown) to locally surface treat the FPC 140, as illustrated in FIG. 5B (S500). At this time, an amount of the irradiated ion can be in a range of about 10¹³ ˜10¹⁸ ions/cm². Meanwhile, the operator may also inject reaction gases, such as oxygen gas, nitrogen gas, or the like to the FPC 140. At this time, an amount of the injected gas can be in a range of about 0 ˜30 ml/min. Therefore, the surface of the FPC 140 originally having a contact angle θ of about 60° and hydrophobicity is changed to a surface having a contact angle θ of not more than 35° and hydrophilicity. As a result, the adhesion of the sealant 160 formed at the surface treatment portion 148 of the FPC 140 is increased.

As described above, in an inkjet cartridge and a method of fabricating the same according to the present general inventive concept, since a portion of an FPC at which a sealant is applied is locally ion beam-treated, an area and a height of a profile of the sealant applied and formed at the portion of the FPC are controlled to have a small size. Therefore, it is possible to solve problems such as ink leakage, nozzle clogging, and the like.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet cartridge comprising:
a cartridge body to store ink therein;
a head attached to the cartridge body to eject the ink stored in the cartridge body externally;
a flexible printed circuit board attached to the cartridge body to be electrically connected to the head;
a sealant to seal an electrical connection portion of the head and the flexible printed circuit board; and
a surface treatment portion which is locally surface-treated on the flexible printed circuit board to form the sealant thereon.

2. The inkjet cartridge according to claim 1, wherein the surface treatment portion is ion beam-treated.

3. The inkjet cartridge according to claim 2, wherein the surface treatment portion has a contact angle of substantially 1˜30°.

4. The inkjet cartridge according to claim 1, wherein the surface treatment portion is disposed around the electrical connection portion.

5. The inkjet cartridge according to claim 1, wherein the head includes pads as electrical input and output terminals, the flexible printed circuit board includes leads exposed externally to be electrically connected to the pads, and the surface treatment portion is disposed around the leads.

6. The inkjet cartridge according to claim 1, wherein the head includes a nozzle to eject the ink, the flexible printed circuit board includes a nozzle exposing part to expose the nozzle externally, and the surface treatment portion is disposed around the nozzle exposing part.

7. The inkjet cartridge according to claim 1, wherein the surface treatment portion is formed to surround the head.

8. The inkjet head according to claim 1, wherein the surface treatment portion is surface-treated to increase hydrophilicity thereof.

9. The inkjet cartridge according to claim 8, wherein the surface treatment portion is surface-treated using one of a plasma surface treatment, a chemical surface treatment, a corona surface treatment, and a ion beam surface treatment to increase the hydrophilicity thereof.

10. The inkjet cartridge according to claim 8, wherein a height and area of the sealant are controlled according to the hydrophilicity of the treated portion of the flexible printed circuit board.

11. The inkjet cartridge of according to claim 1, wherein the head comprises a nozzle to eject the ink therethrough and a wiper to wipe the nozzle, and the sealant is formed at a height such that the sealant does not interfere with the wiping of the nozzle by the wiper.

12. The inkjet cartridge according to claim 1, wherein the sealant adheres to the surface treatment portion of the flexible printed circuit board.

13. A method of fabricating an inkjet cartridge, comprising:
preparing a cartridge body having a head attached thereto, and a flexible printed circuit board having a conductive trace;
locally surface-treating a surface treatment portion of the flexible printed circuit board;
electrically connecting the conductive trace to pads as electrical input and output terminals of the head at the electrical connection portion; and
applying a sealant to the surface treatment portion and the electrical connection portion.

14. The method according to claim 13, wherein the surface treatment portion is ion beam-treated.

15. The method according to claim 14, wherein the surface treatment portion has a contact angle of 1˜30 °.

16. The method according to claim 13, wherein the surface treatment portion is disposed around the electrical connection portion.

17. The method according to claim 13, wherein the head includes a nozzle to eject the ink, and the flexible printed circuit board includes a nozzle exposing portion to expose the nozzle externally, and the surface treatment portion is disposed around the nozzle exposing portion.

18. The method according to claim 13, further comprising:
attaching the flexible printed circuit board to the cartridge body after electrically connecting the conductive trace to the pads and before applying the sealant.

19. The method according to claim 13, further comprising:
attaching a nozzle tape to the cartridge body to seal a nozzle formed at the head after applying the sealant.

20. The method according to claim 13, wherein the surface-treating the surface treatment portion of the flexible printed circuit board comprises:
preparing a mask having a predetermined sized opening, and a flexible printed circuit board having a conductive trace disposed therein;
disposing the mask above the flexible printed circuit board; and
irradiating an ion beam toward the flexible printed circuit board from an upper side of the mask to locally surface treat the surface treatment portion of the flexible printed circuit board.

21. The method according to claim 20, wherein the irradiating the ion beam to surface treat the surface treatment portion of the flexible printed circuit board comprises injecting a reaction gas to the flexible printed circuit board.

22. The method according to claim 21, wherein the reaction gas is one of an oxygen gas and a nitrogen gas.

23. The method according to claim 22, wherein the flexible printed circuit board comprises a lead having one end connected to the conductive trace and the other end exposed externally, and the mask is disposed to allow the opening to be located on the lead.

24. The method according to claim 23, wherein the opening has a size larger than a disposition range of the lead.

25. The method according to claim 24, wherein the flexible printed circuit board comprises a nozzle exposing part opened by a predetermined size, the lead is exposed in the nozzle exposing part, and the opening has a size larger than that of the nozzle exposing part.

26. The method according to claim 20, wherein the disposing the mask above the flexible printed circuit board comprises:
positioning the predetermined sized opening of the mask directly above the surface treatment portion of the flexible printed circuit board.

27. The method according to claim 13, wherein the locally surface-treating of the surface treatment portion comprises:
increasing hydrophilicity of the surface treatment portion.

28. A method of a flexible printed circuit board of an inkjet cartridge, comprising:
preparing a mask having an opening of a predetermined size, and a flexible printed circuit board having a conductive trace disposed therein;
disposing the mask above the flexible printed circuit board; and
irradiating an ion beam toward the flexible printed circuit board from an upper side of the mask to locally surface treat a portion of the flexible printed circuit board aligned with the opening of the mask.

29. The method according to claim 28, further comprising:
injecting a reaction gas to the portion of the flexible printed circuit board aligned with the opening of the mask.

30. The method according to claim 29, wherein the reaction gas comprises one of an oxygen gas and a nitrogen gas.

31. The method according to claim 30, wherein the flexible printed circuit board comprises a lead having a first end connected to the conductive trace and a second end exposed externally, and the mask is disposed to allow the opening to be aligned with the lead.

32. The method according to claim 31, wherein the predetermined size of the opening is larger than a disposition range of the lead.

33. The method according to claim 32, wherein the flexible printed circuit board comprises an opened nozzle exposing portion, the lead is exposed in the nozzle exposing portion, and the predetermined size of the opening of the mask is larger than a size of the nozzle exposing portion.

34. A method of an inkjet cartridge, the method comprising: forming a head on a cartridge body;
forming a flexible printed circuit board having a surface treated portion and a non surface treated portion on the cartridge body; and
forming a sealant on the surface treated portion of the flexible printed circuit board and a portion of the head.

35. The method according to claim 34, wherein the flexible printed circuit board comprises a lead and one or more insulating layers, and the forming of the flexible printed circuit board comprises:
forming the surface treated portion having hydrophilicity on at least one of the lead and one or more insulating layers.
